(19) United States
(12) Patent Application Publication
(10) Pub. No.: US 2009/0006919 A1
(43) Pub. Date: Jan. 1, 2009

(54) INFORMATION APPENDED-AMENDMENT METHOD

(76) Inventor: Xiaojing Xu, Beijing (CN)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/145,750

(22) Filed: Jun. 25, 2008

(30) Foreign Application Priority Data
Jun. 29, 2007 (CN) 200710118192.6

(51) Int. Cl. G06F 11/14

(52) U.S. Cl. 714/747; 714/E11.141

(57) ABSTRACT

An information appended-amendment method and system. The information appended-amendment method includes the steps of locating erroneous information sent by a sender, amending the sent erroneous information in accordance with the location of the sent erroneous information, sending error amendment information to a receiver, and amending the sent erroneous information received by the receiver from the sender by using the error amendment information. It is possible to make amendments to any erroneous information while refreshing screens of two parties so as to erase any erroneous character completely, or mark any amended content. In this way, users will have better communication experiences.

### RELATED APPLICATION

The present application claims priority to Chinese Application No. 200710118192.6 filed Jun. 29, 2007, which is incorporated herein in its entirety by reference.

### BACKGROUND OF THE INVENTION

1. Field of the Invention

The present invention relates to communications field, and in particular to an information appended-amendment method.

2. Description of Prior Art

With the popularization of various communications technologies, people can communicate with each other in a growing number of ways and forms. A variety of devices, such as PCs and mobile phones, have served as information carriers. Communication through visible text information is generally a preferred option for most people, due to hardware limitation of various devices or constraints on application scenarios. When communicating by means of text (e.g., short message), especially when chatting through an instant messenger (e.g., QQ, MSN), people often pursue a quick inputting of information in order to keep smooth and timely communication. More than once, only after habitually pressing the button to send a message, they find errors in the input information due to various reasons, such as wrong usage of some input method or pressing of certain buttons. Such errors may cause confusion or ambiguity to the other party, and he or she will feel uncomfortable even if he or she may guess the meaning of the message. In the case that both parties' information is visible, the sender usually re-enters the information or takes a sequence of acts (copy, amend and send), aiming to clarify his or her intention. Those errors, however, will remain in the conversation record and cannot be canceled.

Users will have better communication experiences if amendment can be made on any erroneous information while refreshing screens of two parties so as to erase any erroneous character completely or mark any amended content.

### SUMMARY OF THE INVENTION

In view of the one or more problems described above, the present invention provides an information appended-amendment method.

The information appended-amendment method according to the present invention comprises steps of:

S 102, locating erroneous information sent by a sender;

S 104, amending the sent erroneous information in accordance with the location of the sent erroneous information;

S 106, sending error amendment information to a receiver; and

S108, amending the sent erroneous information received by the receiver from the sender by using the error amendment information.

An information appended-amendment system according to the present invention comprises:

Information location means which locates erroneous information sent by a sender;

Error amendment means which amends the sent erroneous information in accordance with the location of the sent erroneous information;

Amendment sending means which sends error amendment information to a receiver; and

Information amendment means which amends the sent erroneous information received by the receiver from the sender by using the error amendment information.

With the present invention, it is possible to make amendment on any erroneous information while refreshing screens of two parties so as to erase any erroneous character completely or mark any amended content. In this way, users will have better communication experiences.

### BRIEF DESCRIPTION OF THE DRAWINGS

The figures given here are intended to provide a deeper understanding of the present invention and constitute part of the application. The exemplary embodiments and description thereof in the present invention are intended to explain the present invention rather than limit the present invention. In the figures:

FIG. 1 is a flowchart of an information appended-amendment method according to an embodiment of the present invention;

FIG. 2 is a block diagram of an information appended-amendment system according to an embodiment of the present invention.

### DETAILED DESCRIPTION OF PREFERRED EMBODIMENTS

Now, embodiments of the present invention will be specifically described by example of instant messenger and with reference to the figures.

The emergence of instant communication has a close and indispensable relationship with the Internet. Technically speaking, Instant Messenger (abbreviated as IM) is realized completely on the basis of TCP/IP network protocol family. Following the creation of the first IM product, ICQ, instant communication began to have its own mode in terms of technology and function, and people began to learn its operating principle. However, protocols adopted to implement the technical principles of instant communication vary dramatically with different service providers. Until now, none of the several predominant IM service operators in the world have published their own proprietary protocols for instant communication products. Such a product must conform to the basic principles and structures of IM system for providing the most basic service, no matter how many new functions the current product has.

First, user A enters his or her user name and password and then logs on an IM server. The IM server verifies the user's identity by reading a user database. If both of the user name and the password are correct, the IM server registers user A's IP address, version number of IM client software and the used TCP/UDP port number, and then returns a flag indicating that user A has successfully logged on the server. At this moment, the status of user A in IM system is online presence.

Next, information about the online presence of user A is sent to the computers of user A's instant communication buddies, who are also online at present, based on user A's buddy list stored in the IM server. Such information contains online presence, IP address, TCP port number used at IM client and the like. After instant communication software in each of the computers of these IM buddies receives the information, a small window for notification pops up on the computer desktop.

Then, the instant communication server sends back to the computer of user A his or her buddy list stored in the server and associated information. This information also contains online presence state, IP address, TCP port number used at IM client and the like. After receiving this information, the IM client on user A's computer displays the buddy list and their online presence state.

Further, if necessary, user A can contact with one of his or her buddies in several ways as follows.

### 1. Online Direct Communication

If user A wants to chat with one of his online buddies, user B, user A will send chat information to the computer of user B directly through the user B's information sent from the server, such as IP address and TCP port number. The chat information is received and then displayed on the screen by the IM client software of user B. Next, user B responds directly to the computer of user A. In this way, the instant text messages of the two parties do not need to be forwarded by the IM server, and the two parties can conduct a direct point-to-point communication over the network. Such communication is called peer-to-peer communication.

### 2. Online Agent Communication

In a commercial IM system, the IN server will provide message forwarding service if the point-to-point direct communication between users A and B is hard or slow to establish due to certain reasons, such as a firewall, a network speed, etc. In other words, all of the instant messages of users A and B are first sent to the IM server and then forwarded to the other party by the server.

### 3. Offline Agent Communication

When users A and B cannot keep online simultaneously for some reason, and user A sends a message to user B, the IM server can automatically hold the message from user A and forward it to user B when user B logs on next time.

### 4. Extended Communication Way

User A can sends information to user B via the IM server in an extended manner. For example, information can be sent to user B's mobile phone in the manner of short message transmission, to user B's stationary telephone in the manner of fax transmission, to user B's email box in the manner of email, etc.

In the above four types of communication, interactive information is stored at each client, and the IM server is primarily responsible for the functions of client logon and information forwarding.

The present invention can implement appended-amendments on information by modifying corresponding client protocols.

First, the present invention modifies terminal software protocol, identifies all message entries and maps them to a display section. Thus, when a cursor is located in the region for sent information, or when the information inputting region traces back to sent target information, the terminal can automatically recognize whether the information is sent by itself, as well as the number of corresponding message. On the other hand, the terminal cannot amend any received information.

Next, the present invention modifies transmission protocol and adds support for the information appended-amendment. Having been amended, the target information is sent and identified as appended information. The receiver recognizes the amended information according to the protocol and updates the corresponding information entry. Meanwhile, it updates the display content of the message according to the corresponding relationship with the display section and refreshes the screen.

Finally, the present invention modifies information display protocol and defines the display effect after amendment. The content within the refreshed display region can be amended content which completely replaces the original erroneous content, or can identify any amended part in various forms on the basis of the original content. For example, such identification can be represented in different colors or have a flickering effect, or the correct information can be display immediately under the original information.

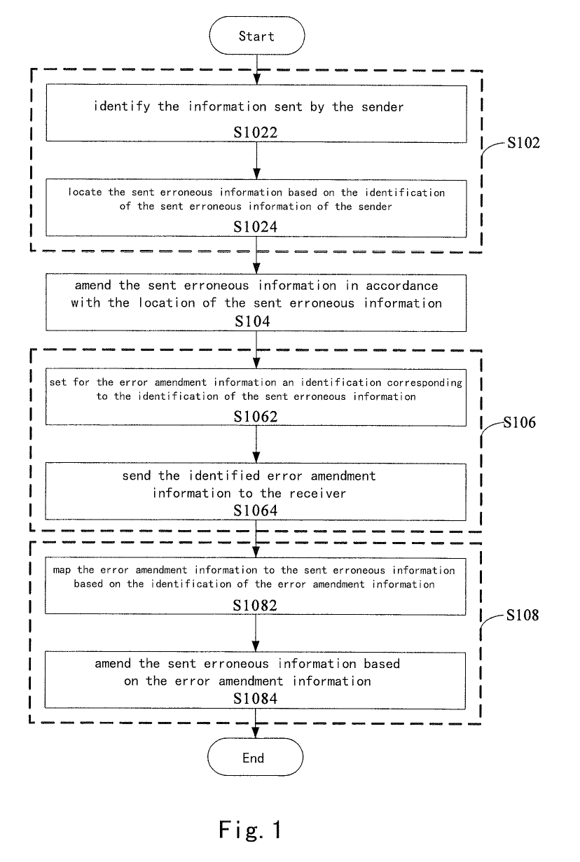

A specific explanation will be given to the information appended-amendment method according to an embodiment of the present invention, with reference to FIG. 1. In this figure, the information appended-amendment method comprises steps of S102, locating erroneous information sent by a sender; S104, amending the sent erroneous information in accordance with the location of the sent erroneous information; S106, sending error amendment information to a receiver; and S108, amending the sent erroneous information received by the receiver from the sender by using the error amendment information.

Step S102 includes steps of S1022, identifying the information sent by the sender, and S1024, locating the sent erroneous information based on the identification of the sent erroneous information of the sender.

Step S106 includes steps of S1062, setting for the error amendment information an identification corresponding to the identification of the sent erroneous information, and S1064, sending the identified error amendment information to the receiver.

Step S108 includes steps of S1082, mapping the error amendment information to the sent erroneous information based on the identification of the error amendment information, and S1084, amending the sent erroneous information based on the error amendment information.

Here, a variety of user-friendly measures can be adopted to quickly locate an information entry to be amended. The target information can be amended through various fast and convenient editing methods. The transmission of a message with appending protocol enables the receiver to recognize the appended information. Further, display for two or more parties can be refreshed at the same time by selecting a traceless refreshing scheme or appended identification refreshing scheme.

As described above, in the information appended-amendment method according to the present invention, the message sender locates the sent information with some error by displaying a message box at his or her terminal. By adding appended-amendment protocol to the communication transmission means, the sender can make an appended-amendment on the erroneous part of the sent message, so that the displayed information at the receiver end can be refreshed tracelessly or the amended content is remarked on the basis of the original text, Alternately, any other notification measure can be used to remind the receiver of the amended information.

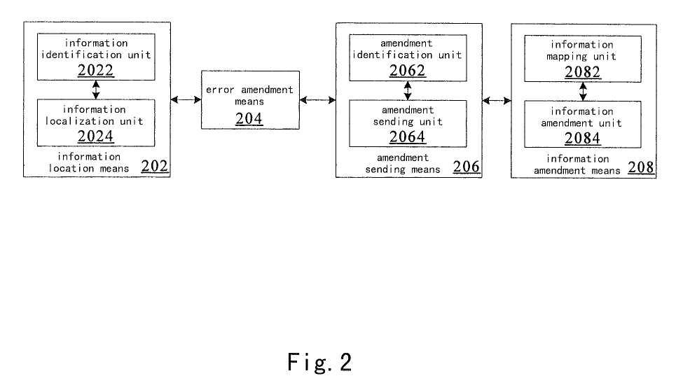

A specific explanation will be given to the information appended-amendment system according to an embodiment of the present invention, with reference to FIG. 2. In this figure, the information appended-amendment system comprises information location means 202 for locating erroneous information sent by a sender, error amendment means 204 for amending the sent erroneous information in accordance with the location of the sent erroneous information, amendment sending means 206 for sending error amendment information to a receiver, and information amendment means 208 for amending the sent erroneous information received by the receiver from the sender by using the error amendment information.

The information location means 202 includes information identification unit 2022 for identifying the information sent by the sender, and information localization unit 2024 for locating the sent erroneous information based on the identification of the sent erroneous information of the sender.

The amendment sending means 206 includes amendment identification unit 2062 for setting for the error amendment information an identification corresponding to the identification of the sent erroneous information, and amendment sending unit 2064 for sending the identified error amendment information to the receiver.

The information amendment means 208 includes information mapping unit 2082 for mapping the error amendment information to the sent erroneous information based on the identification of the error amendment information, and information amendment unit 2084 for amending the sent erroneous information based on the error amendment information.

With the present invention, any error caused by carelessness can be amended timely during message communication, and the screens of the communicating parties can be refreshed at the same time. Therefore, any error in text or other types of information can be solved so as to optimize the communication experience of each party. The user's effort of inputting information amendments can be reduced, especially for devices with small keypads, such as Personal Digital Assistants, mobile phones and the like.

The foregoing description illustrates merely the preferred embodiments of the present invention and is not intended to limit the scope of the present invention. For those skilled in the art, various modifications and variations can be made to the present invention. Any change, substitution or improvement within the spirit and principle of the present invention should fall into the scope of the present invention.

What is claimed is:

1. An information appended-amendment method, comprising steps of:
locating erroneous information sent by a sender;
amending said sent erroneous information in accordance with a location of said sent erroneous information;
sending error amendment information to a receiver; and
amending said sent erroneous information received by said receiver from said sender by using said error amendment information.

2. The information appended-amendment method of claim 1, wherein said step of locating erroneous information sent by a sender comprises the steps of:
identifying the information sent by said sender; and
locating said sent erroneous information based on the identification of said sent erroneous information of said sender.

3. The information appended-amendment method of claim 2, wherein said step of sending error amendment information to a receiver comprises the steps of:
setting for said error amendment information an identification corresponding to the identification of said sent erroneous information; and
sending the identified error amendment information to said receiver.

4. The information appended-amendment method of claim 3, wherein said step amending said erroneous information received by said receiver from said sender by using said error amendment information comprises the steps of:
mapping said error amendment information to said sent erroneous information based on the identification of said error amendment information; and
amending said sent erroneous information based on said error amendment information.

5. The information appended-amendment method of claim 4, wherein said sent information is identified by modifying terminal software protocol.

6. The information appended-amendment method of claim 5, wherein said error amendment information is sent to said receiver by modifying transmission protocol.

7. The information appended-amendment method of claim 6, wherein the display mode of the sent erroneous information after amendment is defined by modifying information display protocol.

8. The information appended-amendment method of claim 1, wherein said method is applicable to text information communication.

9. The information appended-amendment method of claim 1, wherein said method is applicable to instant message communication.

10. The information appended-amendment method of claim 1, wherein said method is applicable to short message communication.

11. An information appended-amendment system, comprising:
information location means which locates erroneous information sent by a sender;
error amendment means which amends the sent erroneous information in accordance with the location of said sent erroneous information;
amendment sending means which sends error amendment information to a receiver; and
information amendment means which amends said sent erroneous information received by said receiver from said sender by using said error amendment information.

12. The information appended-amendment system of claim 11, wherein said information location means comprises:
an information identification unit for identifying the information sent by said sender; and
an information localization unit for locating the sent erroneous information based on the identification of said sent erroneous information of the sender.

13. The information appended-amendment system of claim 12, wherein said amendment sending means comprises:
an amendment identification unit for setting for said error amendment information an identification corresponding to the identification of said sent erroneous information; and
an amendment sending unit for sending the identified error amendment information to said receiver.

14. The information appended-amendment system of claim 13, wherein said information amendment means comprises:
an information mapping unit for mapping said error amendment information to said sent erroneous information based on the identification of said error amendment information; and
an information amendment unit for amending said sent erroneous information based on said error amendment information.

15. The information appended-amendment system of claim 14, wherein said sent information is identified by modifying terminal software protocol.

16. The information appended-amendment system of claim 15, wherein said error amendment information is sent to said receiver by modifying transmission protocol.

17. The information appended-amendment system of claim 16, wherein the display scheme of the sent erroneous information after amendment is defined by modifying information display protocol.

18. The information appended-amendment system of claim 11, wherein said method is applicable to text-information communication.

19. The information appended-amendment system of claim 11, wherein said method is applicable to instant message communication.

20. The information appended-amendment system of claim 11, wherein said method is applicable to short message communication.
